(19) United States
(12) Patent Application Publication
(10) Pub. No.: US 2016/0168312 A1
(43) Pub. Date: Jun. 16, 2016

(54) ALLOPHANATE COMPOSITION

(71) Applicant: VENCOREX FRANCE, SAINT-PRIEST (FR)

(72) Inventors: Rolf KLUCKER, Caluire-et-Cuire (FR); Jean-Marie BERNARD, Saint-Laurent-d'Agny (FR)

(21) Appl. No.: 14/778,507

(22) PCT Filed: Mar. 19, 2014
(86) PCT No.: PCT/EP2014/055537

§ 371 Date: Sep. 18, 2015

(30) Foreign Application Priority Data
Mar. 19, 2013 (FR) 13 52465

(51) Int. Cl. C08G 18/78; C08G 18/79; C08G 18/46; C09D 175/02

(52) U.S. Cl. CPC C08G 18/7837; C09D 175/02; C08G 18/792; C08G 18/7831; C08G 18/7887; C08G 18/4623

(57) ABSTRACT

The invention relates to a composition for producing a coating comprising (a) a compound comprising at least two secondary amino functions and (b) isocyanate component comprising an allophanate and a polydunctional isocyanate, and (c) optionally a solvent. The invention also relates to the use of said composition for producing a coating with improved hydrophobicity, and for improving the pot life duration (pot life property) of a formulation for paint or for varnish, or for improving the opening time of a film or a layer resulting from the application of said composition.

The invention relates to a composition for preparing a coating comprising (a) at least one compound comprising at least two secondary amine functions and (b) an isocyanate component comprising at least one allophanate and at least one polyfunctional isocyanate, and optionally a solvent.

In particular, the invention relates to a composition for preparing a coating comprising

(a) at least one compound selected from
a compound of formula (Q)

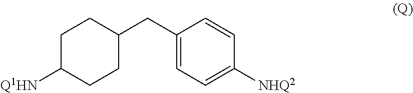

a compound comprising at least two secondary amine functions and obtained by reaction (a1) of at least one compound including at least one primary amine function and (a2) of at least one compound including a double bond (C═C) located in position a of an ester function (C(O)OR) or of at least one compound including a double bond (C═C) located in position a of a nitrile function (CN) or of mixtures thereof;
a mixture of a compound of formula (Q) and of a compound comprising at least two secondary amine functions and stemming from steps (a1) and (a2);

(b) an isocyanate component with NCO functionality ranging from 1.5 to 4.5; preferably ranging from 1.6 to 3.5; more preferentially ranging from 1.7 to 3; and comprising (b1) at least one allophanate of formula (I) and with NCO functionality equal to 2+/−0.1 and (b2) at least one polyfunctional isocyanate; and wherein the mass ratio between the amount of allophanate (b1) and the amount of polyfunctional isocyanate (b2) ranges from 1/99 to 50/50.

The invention also relates to the use of this composition for preparing a coating, the hydrophobicity of which is improved, as well as for improving the pot lifetime (pot life property) of a paint or varnish formulation or for improving the opening time of a film or of a layer resulting from the application of this composition.

The invention also relates to the use of this composition for preparing a low viscosity coating composition as co mPared with the compositions of the state of the art.

Allophanates intended for coating compositions are known. WO-2010/067005 describes a method for preparation of allophanate as well as an allophanate and a composition comprising the allophanate and intended for preparing coating compositions, in particular paint compositions.

The use of resins, for example polyurethane resins for preparing a coating is known. These known polyurethane resins may have problems of reactivity or problems of reaction rate.

The resins for preparing a coating of the state of the art also cause problems related to the presence of volatile organic compounds, in particular upon application of low molecular mass resins.

The resins of the state of the art may also have viscosity problems.

The compositions for preparing a coating of the state of the art also have problems with sensitivity to ambient humidity during their application. Ambient humidity may lead to accelerated drying of the prepared coating layer.

Moreover, the compositions of the state of the art may lead to coatings having flexibility problems.

Such compositions may also lead to coatings for which the successively applied layers or the layers partly overlap and have over-thicknesses. These over-thicknesses may therefore be defects of the prepared coating.

The compositions of the state of the art may also have insufficient pot lifetimes which may make them unusable. In such cases, doubling of the viscosity of the compositions of the state of the art is too fast and leads to problems for applying these compositions.

The compositions of the state of the art do not always allow preparation of coatings for which the hydrophobicity is satisfactory although this is an important property.

Further, the compositions of the state of the art generally comprise significant amounts of solvent in order to lower or control their viscosity. These solvents are usually volatile organic compounds (VOC) or else sources of such VOCs.

Therefore there exists a need for isocyanate-based compositions having improved properties.

The invention therefore gives the possibility of providing a solution to all or part of the problems related to the compositions for preparing a coating of the state of the art.

Thus, the present invention provides a composition for preparing a coating which is particularly advantageous in the field for covering floors.

The invention also provides a composition for preparing a coating which is particularly advantageous in the automotive field, in particular for preparing paint or varnish, notably applications for repairing paint or varnish.

The invention provides a composition for preparing a coating comprising
(a) at least one compound selected from
   a compound of formula (Q)

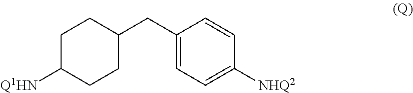

wherein Q¹ and Q², either identical or different, represent a linear, branched or cyclic alkyl group, comprising from 1 to 20 carbon atoms, in particular from 2 to 12 carbon atoms or from 2 to 6 carbon atoms or at least 3 carbon atoms, notably selected from methyl, ethyl, propyl, isopropyl, butyl, isobutyl, tertiobutyl, the different linear, branched or cyclic isomers of pentyl, hexyl, heptyl, octyl, nonyl and decyl;
a compound comprising at least two secondary amine functions and obtained by reaction
   (a1) of at least one compound including at least one primary amine function and
   (a2) of at least one compound including a double bond (C═C) located in position a of an ester function (C(O)OR) or of at least one compound including a double bond (C═C) located in position a of a nitrile function (CN) or mixtures thereof;
a mixture of a compound of formula (A) and of a compound comprising at least two secondary amine functions and stemming from steps (a1) and (a2);
(b) an isocyanate component with NCO functionality ranging from 1.5 to 4.5; preferably ranging from 1.6 to 3.5; more preferentially ranging from 1.7 to 3; and comprising
   (b1) at least one allophanate of formula (I) and with NCO functionality equal to 2+/−0.1.

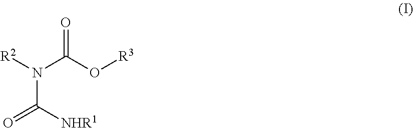

wherein

R¹ and R², either identical or different, represent a hydrocarbon group, comprising a derivatized or non-derivatized isocyanate function;

R³ represents the radical resulting from the reaction of the isocyanate function with the hydrogen of the OH function of an alcohol comprising an ether or polyether function and selected from a silanol; an aliphatic monoalcohol with a linear C₁₂-C₂₀ chain; an aliphatic monoalcohol with a branched C₁₂-C₂₀ chain; a diol with a linear C₂-C₄₀ chain or a diol with a branched C₃-C₄₀ chain, for which at least one of the hydroxyl groups is substituted and which has the formula

T¹-[O—CH(T²)-CH₂]ₙ—OH

wherein T¹ represents a linear C₁-C₂₀ alkyl group; a branched C₁-C₂₀ alkyl group; a group of formula T³-CO—CH₃ wherein T³ represents a linear C₁-C₂₀ alkyl group or a branched C₁-C₂₀ alkyl group; T² represents H; an alkyl group, preferably a C₁-C₈ alkyl group, notably methyl; an ether group, notably a group of formula —CH₂OT⁴ wherein T⁴ represents a hydrocarbon chain, notably a polyalkylene chain or a polyoxyalkylene chain, preferably a polyoxyethylene chain; n represents an integer, preferably an integer ranging from 1 to 50; and
(b2) at least one polyfunctional isocyanate; and
(b3) in which the mass ratio between the amount of allophanate
(b1) and the amount of polyfunctional isocyanate (b2) ranges from 1/99 to 50/50.

According to the invention, for the compound (a2) including a double bond (C═C) located in position a of a nitrile function (CN), this function may therefore also be a cyano group and may be represented by the formula C ≡N.

Advantageously according to the invention, the composition is such that the molar ratio [b/a] defined by [number of NCO functions of the component (b)]/[number of NH functions of the compound (a)] ranges from 0.7 to 1.3; 0.9 to 1.2; from 1 to 1.2; from 0.8 to 1.2; from 0.9 to 1.2; from 0.8 to 1.1; from 0.9 to 1.1; from 1 to 1.1 or is equal to 1.

Preferably for the composition of the invention,
the compound (a1) comprises at least one primary amine function and at least one group selected from a hydrocarbon chain; a hydrocarbon chain comprising at least one heteroatom selected from O, S, N; a hydrocarbon chain comprising at least one function selected from an ester, ether or carbonate function; a hydrocarbon chain comprising at least one heteroatom selected from O, S, N and at least one function selected from an ester, ether or carbonate function; the hydrocarbon chain being preferably a linear, branched or cyclic C₁-C₂₀ chain; or
for which the compound (a1) is an aminoester compound including at least one primary amine function; or
for which the compound (a2) comprises a double bond (C═C) which may react by Michael addition with the primary amine function of the compound (a1) and which is selected from ester derivatives comprising a double bond (C═C) such as dimethyl maleate, diethyl maleate, dibutyl maleates or fumarates, diethyl fumarate, dimethyl fumarate, ethyl crotonate, butyl crotonate, 2-ethylhexyl crotonate, methyl acrylate, ethyl acrylate, butyl acrylate, 2-ethyl-hexyl acrylate, ethyl methacrylate, butyl methacrylate, 2-ethylhexyl methacrylate, hydroxy alkyl acrylates, hydroxy alkyl methacrylates, diethyl itaconate, methyl-cyclohexene-1-carboxylate; or
for which the compound (a2) is a compound selected from a compound including doubles bonds (C═C) located in α positions of ester functions (C(O)OR) such as an alkyl polyacrylate, an alkyl triacrylate, an alkyl diacrylate, an alkyl polymethacrylate, an alkyl trimethacrylate, an alkyl dimethacrylate, an alkyl polymaleate, an alkyl trimaleate, an alkyl dimaleate, like hexanediol diacrylate, hexanediol dimethacrylate, 2-ethyl hexanediol diacrylate, 2-ethyl hexanediol dimethacrylate, cyclohexanediol diacrylate, cyclohexanediol dimethacrylate, trimethylolpropane triacrylate, trimethylolpropane methacrylate, trimethylolpropane triacrylate comprising oligoethylene glycol functions, trimethylolpropane methacrylate comprising oligoethylene glycol functions, pentaerythritol tetramethacrylate, pentaerythritol tetraacrylate, pentaerythritol methacrylate, hexanediol itaconate, polyethylene glycol diacrylate with a number average molecular mass (Mₙ) comprised between 200 and 2,000, polyethylene glycol methacrylate with an average number molecular mass (Mₙ) comprised between 200 and 2,000, acrylate or methacrylate derivatives of diol or triol or tetraol polycaprolactone with a number average molecular mass (Mₙ) comprised between 200 and 2,000, acrylate or methacrylate derivatives of polyols with carbonate functions; or
combines these definitions of the compounds (a1) and (a2).

Advantageously, the compound (a1) may also be selected from propylamine, diisopropylamine, cyclohexylamine, ethyl glycinate, dimethyl aspartate, methyl or ethyl aminocaproate, ethyl amino-undecanoate, propyl phenylalaninate, ethyl lysinate, ethyl amino-isobutyrate, 1-methoxy-2-propanamine, phenylethylamine, 4-methoxybenzylamine, 4,11-dioxa-tetradeca-1,14-diamine, aminomethyl thiophene, ether-amines selected from the amines RN-CAS-9046-10-0, RN-CAS-72088-96-1, RN-CAS-27417-83-0, RN-CAS-103659-01-4 or mixtures thereof.

Also advantageously, the compound (a1) may be selected from ethylenediamine, 1,4-diaminobutane, 2-methyl-1,5-diaminopentane, 1,6-diaminohexane, 2,2,4-trimethyl-1,6-diaminohexane, 2,4,4-trimethyl-1,6-diaminohexane, 1-amino-3,3,5-trimethyl-5-aminomethyl-cyclohexane, 4,4′-diamino-dicyclohexylmethane, 3,3-dimethyl-4,4′-diamino-dicyclohexylmethane or mixtures thereof.

Advantageously, the preparation of polyfunctional amino acids with a primary amine function, as a compound (a1) according to the invention, may comprise the esterification reaction of the amino acids in the presence of an acid catalyst and of a polyol including at least one hydroxyl function.

The compound (a1) may also be obtained by esterification of an amino acid by a polyol, for example a diol or a triol.

Also advantageously, it is possible to apply as a compound (a1) according to the invention, an aminoester salt including a primary amine function such as an aminoester hydrochloride with a primary amine function, which, by reaction with a compound (a2) according to the invention, in the presence of a polar solvent and of a base capable of neutralizing the aminoester salt, may give the possibility of obtaining an aminoester compound with a secondary amine function (a). Preferably, the base may be selected from alkaline or earth-alkaline metal carbonates or from tertiary amines.

Advantageously, the different types of compounds (a1) may also be mixed.

Advantageously, for the compound (a2), the maleate and acrylate function may be borne by the same compound. For example, the compound (a2) may be dihydroxyethyl acrylate maleate.

Also advantageously, the compound (a2) may stem from biosourced materials.

Preferably according to the invention, the compound (a) is a compound of formula (II-a):

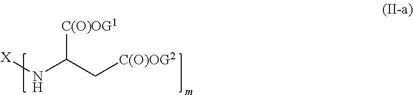

wherein

m represents an integer equal to or greater than 2, notably an integer ranging from 2 to 30, for example an integer ranging from 2 to 10 or from 2 to 6;

X represents a radical with valence equal to m and selected from an organic radical, a hydrocarbon radical, a C₂-C₅₀ hydrocarbon radical; resulting from the removal of the primary amine functions of the compound (a1);

G¹ and G², either identical or different, independently represent an organic radical, a hydrocarbon radical or a hydrocarbon radical which is inert towards isocyanate functions under the preparation conditions of the composition.

Also preferably according to the invention, the compound (a) is a compound of formula (II-b):

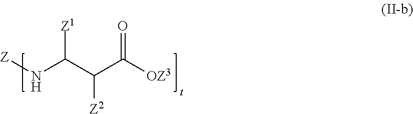

wherein

t represents an integer equal to greater than 2, notably an integer ranging from 2 to 30, for example an integer ranging from 2 to 10 or from 2 to 6;

Z represents a radical with valence equal to m and selected from an organic radical, a hydrocarbon radical, a C₂-C₅₀ hydrocarbon radical; resulting from the removal of the primary amines functions of the compound (a1);

Z¹ independently represents hydrogen or a C₁-C₄-alkyl group, in particular methyl;

Z² independently represents hydrogen or a C₁-C₄-alkyl group, in particular methyl;

Z³ independently represents an organic radical, a hydrocarbon radical or a hydrocarbon radical inert towards isocyanate functions under the preparation conditions of the composition.

Also preferably, the invention applies a mixture of at least one compound of formula (II-a) and of at least one compound of formula (II-b).

Preferably, for the compound of formula (II) and under the preparation conditions of the composition according to the invention, G¹, G², Z¹, Z² and Z³ are inert towards isocyanate functions, in particular towards isocyanate functions of the isocyanate component (b). Thus and preferably, G¹, G², Z¹, Z² and Z³ do not comprise any group comprising reactive hydrogen atoms of the Zerevitinov type.

The compounds of formula (II) according to the invention are generally prepared in a way known to one skilled in the art. Temperatures ranging from 0 to 100° C. are generally suitable.

According to the invention, the compound (a) may be a compound of formula (II) wherein X represents a divalent radical comprising up to 40 carbon atoms, preferably a radical selected from the radicals of formulae (X¹) to (X⁶)

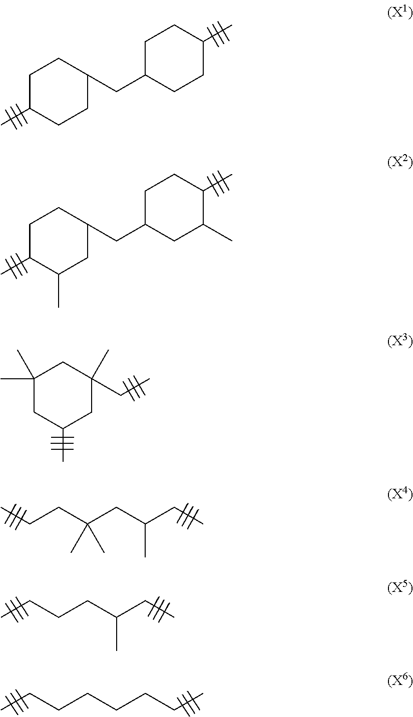

According to the invention, the groups are covalently bound to the other groups or atoms making up the molecule via the bond represented by the symbol [symbol] .

The compound (a) may also be a compound of formula (II), in which X represents an organic radical of valence m and is obtained by reaction of a compound (a1) selected from 1,4-diaminobutane, 2-methyl-1,5-diaminopentane, 1,6-diaminohexane, 2,2,4-trimethyl-1,6-diaminohexane, 2,4,4-trimethyl-1,6-diaminohexane, 1-amino-3,3,5-trimethyl-5-amino-methylcyclohexane, 4,4′-diaminodicyclohexylmethane, 3,3′-dimethyl-4,4′-diamino-dicyclohexylmethane.

The compound (a) may also be an amino acid which may be obtained from diverse sources. These amino acids may be obtained by hydrolysis of animal proteins or plant proteins. They may also be obtained by fermentation of products of plant origin such as glycerol, glucose or other saccharide compounds.

Methods for preparing esters of amino acids are known. Mention may be made of the methods described in the following text books: Protective groups in Organic synthesis of Greene and Wuts, ed. Wiley Intersciences, The practice of peptide synthesis 1994 Bodanszky M and A Springer Verlag Heidelberg, The peptides Vols. 1-5 Gross and Meienhofer Academic Press New York.

According to the invention, the composition advantageously comprises

a compound (a) for which the molecular mass ranges from 400 to 6,500 g·mol⁻¹, preferably from 400 to 800 g·mol⁻¹; or

a compound (a) for which the NH functionality ranges from 2 to 30, preferably from 2 to 6; or

a compound (a) of formula (II) according to claims 4 or 5 wherein X represents an organic radical of valence m and is obtained by reaction of a compound (a1) selected from ethylenediamine, 1,2-diaminopropane, 1,4-diaminobutane, 2-methyl-1,5-diaminopentane, 1,6-diaminohexane, 2,5-diamino-2,5-dimethylhexane, 2,2,4-trimethyl-1,6-diaminohexane, 2,4,4-trimethyl-1,6-diaminohexane, 1,11-diamino-undecane, 1,12-diaminododecane, 1-amino-3,3,5-trimethyl-5-aminomethylcyclohexane, 2,4-hexahydrotolylenediamine, 2,6-hexahydrotolylenediamine, 2,4′-diaminodicyclohexylmethane, 4,4′-diamino-dicyclohexylmethane, 3,3′-dimethyl-4,4′-diamino-dicyclohexylmethane, 2,4,4′-triamino-5-methyldicyclohexylmethane and polyetherpolyamines substituted with at least one primary amino-aliphatic group, the average molecular mass of which ranges from 148 to 6,000 g/mol.

According to the invention, the composition comprises at least one allophanate of formula (I) for which the NCO functionality is equal to 2+/−0.1. The NCO functionality of the allophanate of formula (I) according to the invention may therefore have a certain variation around the value 2, this variation is generally of about +/−5%.

The advantages of the composition according to the invention are generally also accessible with an allophanate of formula (I) and with NCO functionality equal to 2+/−0.3.

Advantageously, the composition according to the invention comprises an isocyanate component (b) for which the compound (b1) is a compound of formula (I) wherein R¹ and R², either identical or different, represent a group comprising a derivatized or non-derivatized isocyanate function and selected from an aliphatic, cycloaliphatic, heterocyclic or aromatic hydrocarbon group, preferably an aliphatic hydrocarbon group comprising a derivatized or non-derivatized isocyanate function.

Also advantageously, the derivatized isocyanate function of the allophanate (b1) is different from an isocyanurate function and is selected from carbamate, urea, biuret, urethane, uretinedione, acylurea, masked isocyanate, allophanate functions.

According to the invention, the allophanate (b1) may be a homo-allophanate, R¹ and R² being identical, or else the allophanate (b1) may be a mixed allophanate, R¹ and R² being different.

The composition according to the invention may comprise a mixture of allophanates (b1). The mixture of allophanates (b1) may comprise at least 25% by mass, advantageously at least 33% by mass, preferably at least 50% by mass, of at least one monoallophanate (b1).

The mixture of allophanates may also comprise at least one allophanate selected from a bis-allophanate, a tris-allophanate, one or several heavy allophanates, as well as in a minority way, a carbamate of isocyanate of formula R²NCO and alcohol of formula R³OH or carbamate of isocyanate of formula R¹NCO and alcohol of formula R³OH or a mixture of carbamates of isocyanates of formula R²NCO and of formula R¹NCO and of an alcohol of formula R³OH.

Advantageously, the composition according to the invention comprises an isocyanate component (b) for which the compound (b2) is a polyfunctional isocyanate tricondensate, preferably a polyfunctional isocyanate tricondensate of formula (III):

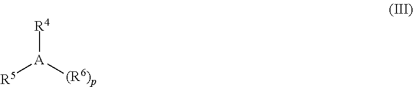

wherein

R⁴, R⁵ and R⁶ independently represent an aliphatic, cycloaliphatic, heterocyclic or aromatic hydrocarbon group or heterocarbon group, comprising at least one derivatized or non-derivatized isocyanate function;

p represents 0, 1 or 2;

A represents a group selected from an isocyanurate group, an imino oxadiazine dione group, an oxadiazine trione group, a biuret group respectively of formulae (A¹) to (A⁴) or a group of formula (A⁵)

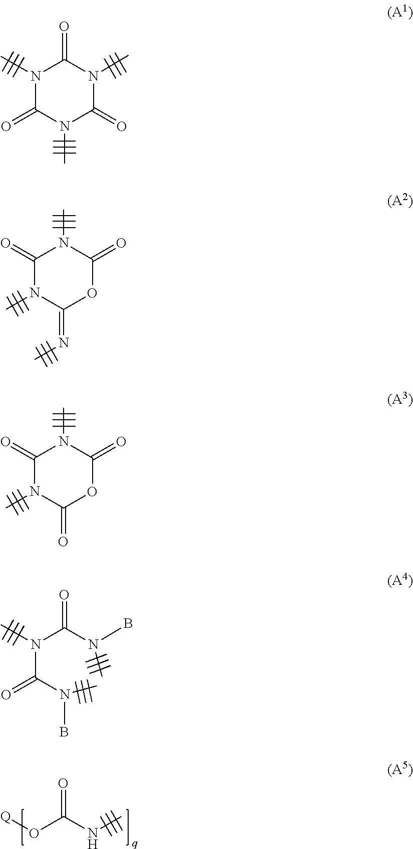

wherein

B independently represents a hydrogen atom; a hydrocarbon group; a C₁-C₂₀ hydrocarbon group; a heterocarbon group comprising at least one heteroatom selected from O, N, S, Si; a C₁-C₂₀ heterocarbon group comprising at least one heteroatom selected from O, N, S, Si;

q represents 3 or 4;

Q represents a group selected from a hydrocarbon group, an alkyl group, a heterocarbon group, an aliphatic, cycloaliphatic, heterocyclic or aromatic heterocarbon group, comprising a derivatized or non-derivatized isocyanate function, a group derived from pentaerythritol, a group derived from trimethylolpropane.

Advantageously, the polyfunctional isocyanate (b2) is a polyisocyanate isocyanurate.

According to the invention, the polyfunctional isocyanate (b2) may be

a polyisocyanate isocyanurate from a tricondensation reaction for which the transformation rate of the isocyanate monomer(s), either identical or different, into a polyfunctional polyisocyanate tricondensate is greater than 8% or greater than 10% or greater than 15%; or

a polyisocyanate isocyanurate comprising between 1 and 99% by weight of biuret or between 2 and 75% by weight of biuret; or

a polyisocyanate isocyanurate from a tricondensation reaction for which the transformation rate of the isocyanate monomer(s), either identical or different, into a polyfunctional polyisocyanate tricondensate is greater than 8% or greater than 10% or greater than 15% and comprising between 1 and 99% by weight of biuret or between 2 and 75% by weight of biuret.

In a particularly advantageous way, the invention also provides a composition for preparing a coating comprising (a) the compound comprising at least two secondary amine functions, (b) the isocyanate component and (c) a solvent.

Many solvents (c) may be suitable. Preferably, the solvent of the composition according to the invention is selected from solvents having a boiling point below 250° C. at atmospheric pressure such as esters, ethers, aromatic compounds or mixtures thereof. As examples, mention may thus be made of n-butyl acetate, methoxy propyl acetate, xylenes, propylene glycol dimethyl ether.

The composition according to the invention comprising a solvent is particularly advantageous for application by spraying, in particular for preparing a coating of paint or varnish for automobiles. In a still more advantageous way, the composition according to the invention comprising a solvent is applied for repairing a paint or varnish coating for automobiles.

The composition according to the invention comprising a solvent is notably advantageous as regards its viscosity, in particular in order to avoid problems of clogging application nozzles. This composition is also advantageous for its improved pot life as well as for the opening time of the prepared paint or varnish film.

The invention also provides the use of a composition according to the invention for preparing a coating or for preparing a cross-linkable coating or for preparing a coating which is cross-linkable by UV irradiation or preparing a coating for which hydrophobicity is improved.

The invention also relates to the use of a composition according to the invention for improving the pot lifetime (pot life property) of a formulation for paint or for varnish.

According to the invention, the pot lifetime is the time during which it is possible to use at room temperature, a composition according to the invention, the components of which have just been mixed, without alteration of the properties.

The invention also relates to the use of a composition according to the invention for improving the opening time of a film or layer resulting from the application of the composition.

Advantageously, the composition according to the invention gives the possibility of preparing a dry coating to dust within a period of time allowing efficient covering and connection of two applied layers in a totally or partly superposed way.

Also advantageously, the composition according to the invention may be applied for allowing leveling or the absence of over-thickness formed during the application of two coating layers.

The different aspects and the advantageous properties of the invention may be illustrated by the following examples. These examples are not a limitation of the scope of this invention.

### EXAMPLES

### Materials

Teraspartic® 277 (Pflaumer Brothers, Inc.) is a cyclic aliphatic resin functionalized with secondary amines, of the polyaspartic acid ester type, identical with Desmophen™ NH-1420 (Bayer MaterialScience). The main characteristics of this product are:

NH functionality: 5.4%,

dynamic viscosity (at 25° C.): 900-2,000 mPa·s,

density: 1.05.

Teraspartic® 292 (Pflaumer Brothers, Inc.) is a cyclic aliphatic resin functionalized with secondary amines, of the polyaspartic acid ester type, identical with Desmophen™ NH-1520 (Bayer MaterialScience). The main characteristics of this product are:

NH functionality: 5.1%,

dynamic viscosity (at 25° C.): 800-2,000 mPa·s,

density: 1.05.

Amicure® IC-221 (Air Products) is a cyclic resin functionalized with secondary amines. The main characteristics of this product are:

equivalent weight by moles of NH functions: 376 g/mol,

dynamic viscosity (at 25° C.): 100-800 mPa·s,

density at (21° C.): 1.06.

Amicure® IC-321 (Air Products) is a cyclic resin functionalized with secondary amines. The main characteristics of this product are:

equivalent weight by moles of NH functions: 379 g/mol,

dynamic viscosity (at 25° C.): 100-800 mPa·s,

density (at 21° C.): 1.05.

Tolonate™ HDT (Vencorex) is a polyisocyanate of the isocyanurate type prepared from hexamethylene diisocyanate. The main characteristics of this product are:

NCO functionality: 22-23%,

dynamic viscosity (at 25° C.): 2,000-2,800 mPa·s,

density (at 25° C.): 1.13 g/cm³.

Tolonate™ HDT-LV (Vencorex) is a polyisocyanate of the isocyanurate type prepared from hexamethylene diisocyanate. The main characteristics of this product are:

NCO functionality: 22-24%,

dynamic viscosity (at 25° C.): 900-1,500 mPa·s,

density (at 25° C.): 1.16 g/cm³.

Tolonate™ HDT-LV2 (Vencorex) is a polyisocyanate of the isocyanurate type prepared from hexamethylene diisocyanate. The main characteristics of this product are:

NCO functionality: 22-24%,

dynamic viscosity (at 25° C.): 450-750 mPa·s,

density (at 25° C.): 1.13 g/cm³.

Tolonate™ HDB-LV (Vencorex) is a polyisocyanate of the biuret type prepared from hexamethylene diisocyanate. The main characteristics of this product are:

NCO functionality: 23%,

dynamic viscosity (at 25° C.): 600 mPa·s,

density (at 25° C.): 1.13 g/cm³.

Tolonate™ X-FLO 100 (Vencorex) is a polyisocyanate of the allophanate type and prepared from hexamethylene diisocyanate. The main characteristics of this product are:

NCO functionality: 12.6%,

dynamic viscosity (at 25° C.): 130 mPa·s,

density (at 20° C.): 1.04 g/cm³.

Desmodur® N 3200 (Bayer MaterialScience) is a polyisocyanate of the biuret type and prepared from hexamethylene diisocyanate. The main characteristics of this product are:

NCO functionality: 22.0-23.0%,

dynamic viscosity (at 23° C.): 1,500-3,500 mPa·s,

density (at 20° C.): 1.13 g/cm³.

Desmodur® N 3900 (Bayer MaterialScience) is a polyisocyanate of the iminooxadiazindione (asymmetrical trimer) type and prepared from hexamethylene diisocyanate. The main characteristics of this product are:

NCO functionality: 23.0-24.0%,

dynamic viscosity (at 23° C.): 630-830 mPa·s,

density: 1.15 g/cm³.

### Preparations

The preparations (A) based on resins of the polyaspartic ester type Teraspartic® 277 and Teraspartic® 292, alone or mixed in different ratios, were prepared and cross-linked with polyisocyanates (B) Tolonate™ HDT-LV2 and Tolonate™ X-FLO 100, alone or mixed in different ratios.

The ratios of the mixtures of (A) and (B) were set by the molar ratios of the NH and NCO functionalities, comprised in (A) and (B) respectively, so that the NCO/NH ratio is constant. In the mentioned examples, the ratio NCO/NH is equal to 1.

Preparations 1: Mixtures of Polyaspartic Resins (A) Used:

| | Amount of | Amount of | Amount of | Amount of |
|---|---|---|---|---|
| Compo- | Teraspartic ® | Teraspartic ® | Amicure ® | Amicure ® |
| sition | 277 | 292 | IC-221 | IC-321 |
| (A) | (% by mass) | (% by mass) | (% by mass) | (% by mass) |
| A1 | 100 | 0 | — | — |
| A2 | 75 | 25 | — | — |
| A3 | 50 | 50 | — | — |
| A4 | 25 | 75 | — | — |
| A5 | 0 | 100 | — | — |
| A6 | — | — | 100 | — |
| A7 | — | — | — | 100 |

Preparations 2: Mixtures of Polyisocyanates (B) Used:

| | Amount of Tolonate ™ | | | | | Amount of | |
|---|---|---|---|---|---|---|---|
| Com- | | HDT- | HDT- | HDB- | X-FLO | Desmodur ® | |
| posi- | HDT | LV | LV2 | LV | 100 | N3200 | N3900 |
| tion | (% by | (% by | (% by | (% by | (% by | (% by | (% by |
| (B) | mass) | mass) | mass) | mass) | mass) | mass) | mass) |
| B1 | — | — | 100 | — | 0 | — | — |
| B2 | — | — | 80 | — | 20 | — | — |
| B3 | — | — | 60 | — | 40 | — | — |
| B4 | — | — | 40 | — | 60 | — | — |
| B5 | — | — | 20 | — | 80 | — | — |
| B6 | — | — | 0 | — | 100 | — | — |
| B7 | 100 | — | — | — | 0 | — | — |
| B8 | 80 | — | — | — | 20 | — | — |
| B9 | — | 100 | — | — | 0 | — | — |
| B10 | — | 80 | — | — | 20 | — | — |
| B11 | — | — | — | 100 | 0 | — | — |
| B12 | — | — | — | 80 | 20 | — | — |
| B13 | | | | 60 | 40 | | |
| B14 | — | — | — | — | — | 100 | — |
| B15 | — | — | — | — | 0 | 80 | — |
| B16 | — | — | — | 80 | — | — | 20 |
| B17 | — | — | — | 60 | — | — | 40 |

### Results

### Example 1

### Time-Dependent Change in the Dynamic Viscosity of the Formulation Versus the Proportion of Tolonate™ X-FLO 100 in the Mixture of Polyisocyanates Used

The dynamic viscosity of the formulations (A)+(B) was measured immediately (within a delay of at least one minute) after mixing the portions (A) and (B), for mixture ratios observing a molar ratio between the NCO and NH functionalities equal to 1. The measurements of dynamic viscosity were conducted by means of a viscosimeter Rheomat RM300 with constant shearing rate (150 s⁻¹).

| | | Measured dynamic | Modeled dynamic |
|---|---|---|---|
| Compo- | Compo- | viscosity | viscosity |
| sition (A) | sition (B) | (in mPa · s) | (in mPa · s) |
| A1 | B1 | 1,161.3 | 1,139.7 |
| A1 | B2 | 969.1 | 971.2 |
| A1 | B3 | 788.0 | 808.4 |
| A1 | B4 | 627.3 | 650.9 |
| A1 | B5 | 480.7 | 498.5 |
| A1 | B6 | 362.1 | 351.0 |
| A2 | B1 | 1,259.4 | 1,275.3 |
| A2 | B2 | 1,140.0 | 1,082.3 |
| A2 | B3 | 934.6 | 895.9 |
| A2 | B4 | 691.5 | 715.5 |
| A2 | B5 | 566.9 | 541.0 |
| A3 | B1 | 1,297.4 | 1,436.4 |
| A3 | B2 | 1,303.8 | 1,218.8 |
| A3 | B3 | 971.0 | 1,008.4 |
| A3 | B4 | 857.8 | 805.0 |
| A3 | B5 | 585.5 | 608.1 |
| A4 | B1 | 1,611.8 | 1,623.8 |
| A4 | B2 | 1,484.7 | 1,381.2 |
| A4 | B3 | 1,110.7 | 1,146.8 |
| A4 | B4 | 878.1 | 920.0 |
| A4 | B5 | 687.0 | 700.6 |
| A5 | B1 | 1,822.1 | 1,838.2 |
| A5 | B2 | 1,596.5 | 1,570.4 |

The results were modelled with a polynomial function of degree two with volumetric fractions of the various components as variables.

The results show a decrease in the dynamic viscosity with the increase of the proportion of Tolonate™ X-FLO 100 in the composition (B) used.

### Example 2

### Time-Dependent Change in the Pot Lifetime of the Formulation Versus the Proportion of Tolonate™ X-FLO 100 in the Mixture of Polyisocyanates Used

The pot lifetime of the formulations (A)+(B) is determined by evaluating the time required for doubling the dynamic viscosity of the formulation. The pot lifetime was evaluated for mixture ratios observing a molar ratio between the NCO and NH functionalities equal to 1. The measurements of dynamic viscosity were conducted by means of a viscosimeter Rheomat RM300 with constant shearing rate (150 s⁻¹).

| | | Pot lifetime | Gain in pot lifetime |
|---|---|---|---|
| Compo- | Compo- | measured | relatively to the use of B1 |
| sition (A) | sition (B) | (in seconds) | (% in time) |
| A1 | B1 | 280 | — |
| A1 | B2 | 361 | 28.9 |
| A1 | B3 | 441 | 57.5 |
| A1 | B4 | 552 | 97.1 |
| A1 | B5 | 670 | 139.3 |
| A2 | B1 | 331 | — |
| A2 | B2 | 430 | 29.9 |
| A2 | B3 | 541 | 63.4 |
| A2 | B4 | 691 | 108.8 |
| A2 | B5 | 876 | 164.7 |
| A3 | B1 | 422 | — |
| A3 | B2 | 530 | 25.6 |
| A3 | B3 | 730 | 73.0 |
| A3 | B4 | 841 | 99.3 |
| A3 | B5 | 1250 | 196.2 |
| A4 | B1 | 750 | — |
| A4 | B2 | 900 | 20.0 |
| A4 | B3 | 1100 | 46.7 |
| A4 | B4 | 1340 | 78.7 |
| A4 | B5 | 2071 | 176.1 |
| A5 | B1 | 3120 | — |
| A5 | B2 | 4120 | 32.1 |

The pot lifetime of the formulations (A)+(B) is determined by evaluating the time required for doubling the dynamic viscosity of the formulation. The pot lifetime was evaluated for mixture ratios observing a molar ratio between the NCO and NH functionalities equal to 1. The measurements of dynamic viscosity were conducted by means of a rheometer Anton Paar MCR-302 in an oscillation mode in a range of frequencies from 0.1 to 40 s⁻¹.

| | | Pot lifetime | Gain in pot lifetime |
|---|---|---|---|
| Compo- | Compo- | measured | relatively to the use of B1 |
| sition (A) | sition (B) | (in seconds) | (% in time) |
| A6 | B7 | 636 | — |
| A6 | B8 | 854 | 34.3 |
| A6 | B9 | 510 | — |
| A6 | B10 | 595 | 16.7 |
| A6 | B1 | 568 | — |
| A6 | B2 | 626 | 10.2 |
| A6 | B11 | 604 | — |
| A6 | B12 | 686 | 13.6 |
| A7 | B11 | 850 | — |
| A7 | B12 | 1,280 | 50.6 |

The results show an increase in the pot lifetime with the increase of the proportion of Tolonate™ X-FLO 100 in the preparation (B) used.

### Example 3

### Time-Dependent Change of the Opening Time and of the Drying Time of the Films Applied Versus the Proportion of Tolonate™ X-FLO 100 in the Mixture of Polyisocyanates Used

The drying time of the films from the formulations (A)+(B) applied on a substrate of the glass type is evaluated according to the EN ISO 9117-5 standard for mixture ratios observing a molar ratio between the NCO and NH functionalities equal to 1.

| | | Drying time T1: | Gain in drying |
|---|---|---|---|
| | | dry, away from | time T1 relatively |
| Compo- | Compo- | dust, measured | to the use of B1 |
| sition (A) | sition (B) | (in minutes) | (% in time) |
| A1 | B1 | 18 | — |
| A1 | B2 | 25 | 38.9 |
| A1 | B3 | 30 | 66.7 |
| A1 | B4 | 45 | 150.0 |
| A1 | B5 | 80 | 344.4 |
| A2 | B1 | 35 | — |
| A2 | B2 | 41 | 17.1 |
| A2 | B3 | 47 | 34.3 |
| A2 | B4 | 73 | 108.6 |
| A2 | B5 | 180 | 414.3 |
| A3 | B1 | 70 | — |
| A3 | B2 | 90 | 28.6 |
| A3 | B3 | 140 | 100.0 |
| A3 | B4 | 230 | 228.6 |
| A3 | B5 | 540 | 671.4 |
| A4 | B1 | 320 | — |
| A4 | B2 | 450 | 40.6 |

The drying time of the films from the formulations (A)+(B) applied on a substrate of the glass type, is evaluated according to the ASTM D-5895 standard with a mechanical recorder of the drying time of the BK type for mixture ratios observing a molar ratio between the NCO and NH functionalities equal to 1.

| | | | Gain in drying time step II, |
|---|---|---|---|
| | | Drying time step | relatively to the use of |
| Compo- | Compo- | II: tactily dry | respective B1 or B11 |
| sition (A) | sition (B) | (in minutes) | (% in time) |
| A6 | B1 | 51.0 | — |
| A6 | B2 | 59.5 | 16.7% |
| A6 | B3 | 73.5 | 44.1% |
| A7 | B1 | 155 | — |
| A7 | B2 | 180 | 16.1% |
| A7 | B3 | 394 | 119% |
| A6 | B11 | 33.0 | — |
| A6 | B12 | 39.0 | 18.2% |
| A6 | B13 | 45.0 | 36.4% |
| A7 | B11 | 85.0 | — |
| A7 | B12 | 97.0 | 14.1% |
| A7 | B13 | 119 | 40.0% |

The results show an increase in the drying time with the increase of the proportion of Tolonate™ X-FLO 100 in the preparation (B) used.

As the opening time of the film is related to the same reaction mechanisms as the drying time, in the absence of a bound volatile substance, it also increases accordingly.

### Example 4

### Time-Dependent Change in the Contact Angle with De-Mineralized Water According to the Proportion of Tolonate™ X-FLO 100 in the Mixture of Polyisocyanates Used

The hydrophobicity of the surface of the films from the formulations (A)+(B) applied on a substrate is evaluated by measuring the contact angle with de-mineralized water for mixture ratios observing a molar ratio between the NCO and NH functionalities equal to 1.

| Compo- | Compo- | Contact angle |
|---|---|---|
| sition (A) | sition (B) | measured for water |
| A1 | B1 | 68.8° |
| A1 | B2 | 74.1° |
| A1 | B3 | 76.7° |
| A3 | B1 | 61.9° |
| A3 | B2 | 65.5° |
| A3 | B3 | 69.8° |
| A5 | B1 | 71.9° |
| A5 | B2 | 73.2° |
| A5 | B3 | 74.6° |
| A6 | B1 | 72.2° |
| A6 | B2 | 73.1° |
| A6 | B3 | 74.2° |
| A7 | B1 | 71.2° |
| A7 | B2 | 73.1° |
| A7 | B3 | 73.1° |

The results show an increase in the contact angle with the increase of the proportion of Tolonate™ X-FLO 100 in the preparation (B) used. This increase reflects an increase in the hydrophobicity of the surface of the film.

### Example 5

### Compatibility Between Polyisocyanates with Formulations (A) According to the Proportion of Tolonate™ X-FLO 100 in the Mixture of Polyisocyanates Used

The compatibility between resins and polyisocyanates is given by the opacity of the product (A)+(B) which is cross-linked, evaluated for cast masses. The evaluation scale is the following: 0: Limpid, 1: Cloudy, 2: Milky, 3: Translucent, 4: Opaque.

| Compo- | Compo- | Co mPatibility of compositions |
|---|---|---|
| sition (A) | sition (B) | (A) + (B) |
| A6 | B7 | 0 |
| A6 | B8 | 0 |
| A6 | B9 | 2 |
| A6 | B10 | 0 |
| A6 | B1 | 3 |
| A6 | B2 | 1 |
| A6 | B3 | 0 |
| A6 | B11 | 4 |
| A6 | B12 | 2 |
| A6 | B14 | 4 |
| A6 | B15 | 0 |
| A6 | B16 | 4 |
| A6 | B17 | 3 |

The examples show a compatibilizing effect, increasing with the fraction of Tolonate™ X-FLO 100 present in the composition (B), for the Amicure® resins. This compatibilizing effect is also expected for systems with multiple isocyanate components from the moment that they comprise Tolonate™ X FLO 100.

### Example 6

### Preparation of a Compound (a) According to the Invention: An Aminoester with Secondary Amine Functions

In a three-neck reactor, are successively introduced isopropanol, aminoester hydrochloride with amine primary function(s), one equivalent of K₂CO₃ per aminoester hydrochloride to be neutralized and 1 molar equivalent of unsaturated alpha beta ester compound per primary amine function to be functionalized. The concentration of the reagents in the solvent depends on the applied reagents. It is comprised between 10 and 80% by weight. The reaction is left with stirring for 4 hours to 48 hours depending on the reagents used. Depending on the reagents applied, the reaction temperature is comprised between room temperature and the reflux temperature of isopropanol (82° C.). Once the reaction is completed, the reaction medium is cooled and then filtered for removing the potassium chloride and potassium hydrogencarbonate formed as well as for removing the residual potassium carbonate. The reaction solvent and the non-consumed reagents are then removed by evaporation in vacuo.

The structure of the aminoesters with secondary amine functions obtained is then characterized by proton NMR or by carbon NMR.

### Synthesis of the ethyl ester of N (3-ethoxy-3-oxopropyl) lysine

In a three-neck reactor equipped with mechanical stirring and a condenser, are successively introduced 30 g of isopropanol, 2.21 g of potassium carbonate (16 mM) and then 2 g of ethyl lysinate hydrochloride (8 mM). To the stirred reaction medium, are added 1.8 g of ethyl acrylate (18 mM). The temperature of the reaction medium is brought to 30° C. The reaction medium is left with stirring for 31 hours. After cooling to room temperature, the reaction medium is filtered for removing the potassium chloride, the potassium carbonate and the potassium bicarbonate. The filtered solution is then evaporated in vacuo for removing the solvent and unreacted ethyl acrylate. The obtained product is characterized by proton and carbon NMR analysis which indicates that the product is obtained with a molar yield of 89% (table 1).

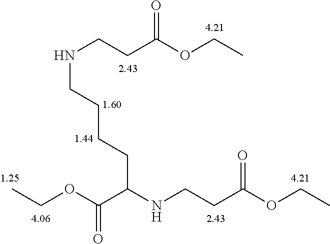 [SMILES: CCOC(=O)CCNCCCCC(NCCC(=O)OCC)C(=O)OCC]

### Examples 7 to 14

### Syntheses of Other Aminoesters According to the Invention Comprising Secondary Amine Functions

The other aminoesters with secondary amine functions of table 1 are prepared according to the operating procedure of Example 6 by adapting the reaction conditions to the reagents used. The reagents, the reaction conditions and the results are shown in Table 1.

TABLE 1

| | | Unsaturated | | | Temperature | |
|---|---|---|---|---|---|---|
| | Initial | alpha beta | | Reaction | and | |
| Ex- | aminoester/ | compound/ | | solvent | reaction | Obtained |
| ample | Amount | Amount | Base | Amount | time | compounds and yield |
| 6 | Ethyl lysinate hydrochloride 2 g (8 mM) | Ethyl acrylate 1.8 g (18 mM) | K₂CO₃ 2.21 g (16 mM) | Isopropanol 30 g | 30° C. 31 h | 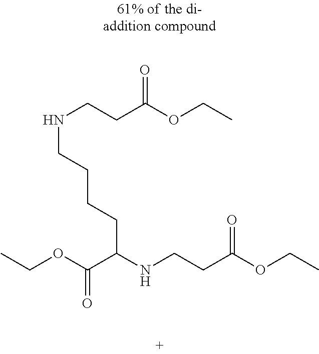 [SMILES: CCOC(=O)CCNCCCCC(NCCC(=O)OCC)C(=O)OCC] |
| | | | | | | 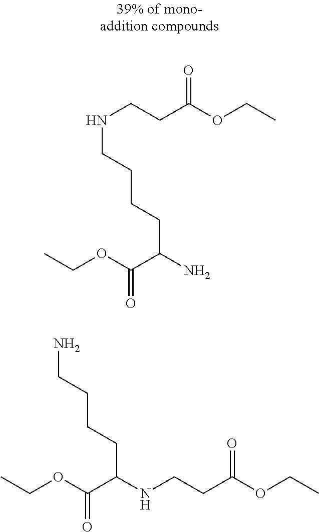 |
| 7 | Ethyl lysinate hydrochloride 2 g (8 mM) | Ethyl acrylate 2.5 g (25 mM) | K₂CO₃ 2.21 g (16 mM) | Éthanol 30 g | 60° C. 31 h | 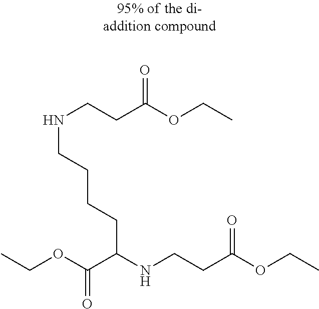 [SMILES: CCOC(=O)CCNCCCCC(NCCC(=O)OCC)C(=O)OCC] |
| 8 | Ethyl lysinate hydrochloride 2 g (8 mM) | Ethyl methacrylate 2.8 g (18 mM) | K₂CO₃ 2.21 g (16 mM) | Propan-2-ol 20 ml | 50° C. 17 h | 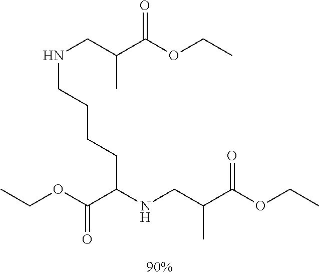 [SMILES: CCOC(=O)C(C)CNCCCCC(NCC(C)C(=O)OCC)C(=O)OCC] |
| 9 | Methyl alaninate phenyl hydrochloride 4.5 g (21 mM) | Hexanediol diacrylate 1.9 g (12 mM) | K₂CO₃ 3 g (21 mM) | Isopropanol 50 ml | 60° C. 8 h | 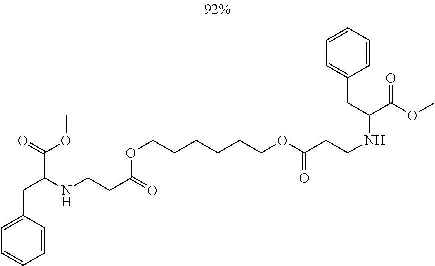 [SMILES: COC(=O)C(Cc1ccccc1)NCCC(=O)OCCCCCCOC(=O)CCNC(Cc1ccccc1)C(=O)OC] |
| 10 | Ethyl valinate hydrochloride 5 g (30 mM) | Hexanediol diacrylate 3.3 g (15 mM) | K₂CO₃ 4.5 g | Isopropanol 100 ml | 70° C. 6 h | 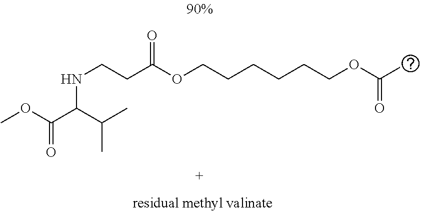 [SMILES: COC(=O)C(NCCC(=O)OCCCCCCOC(C)=O)C(C)C] |
| 11 | Diethyl aspartate hydrochloride 5 g (22 mM) | Hexanediol diacrylate 2.4 g (11 mM) | K₂CO₃ 3.25 g | Isopropanol 100 ml | 65° C. 8 h | 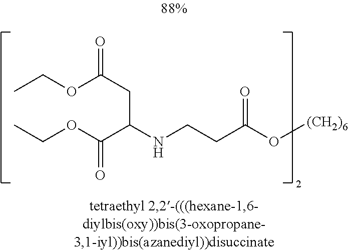 |
| 12 | Benzyl glutamate tosylate 8.3 g (18 mM) | Butanediol diacrylate 1.9 g (11 mM) | Na₂CO₃ 2 g | Isopropanol 150 ml | 60° C. 16 h | 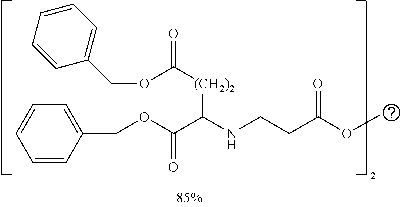 |
| 13 | Ethyl valinate hydrochloride 5 g (30 mM) | Polyethylene glycol diacrylate (Mₙ 575) 8.7 g | K₂CO₃ 4.5 g | Isopropanol | 50° C. 16 h | 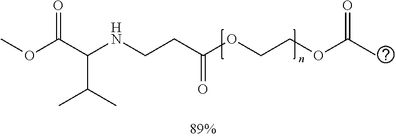 |
| 14 | Diethyl aspartate hydrochloride 5 g (22 mM) | Polyethylene glycol diacrylate (Mₙ 575) 5.8 g | K₂CO₃ 3.5 g | Isopropanol | 50° C. 16 h | 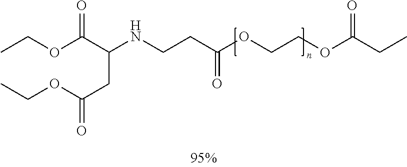 |

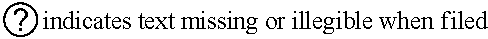

The aminoester ester with a secondary amine function of Examples 6 to 14 is then used for leading to polyurea systems by reaction with an allophanate and another polyisocyanate compound.

### Example 15

### Synthesis of tetrabutyl 2,2′-((6-ethoxy-6-oxohexane-1,5-diyl)bis-(azanediyl))-disuccinate

In a 50 ml three-neck reactor, are successively introduced 45 ml of methanol, 1 g of ethyl lysinate hydrochloride and 1.12 g of potassium carbonate. The reaction medium is stirred at a temperature of 50° C. for 1 hour. The mixture is cooled and then filtered for removing the salts. The methanol is removed in vacuo and then ethyl acetate (30 ml) is added. 1.9 g of dibutyl maleate is then added to the reaction mixture which is left with stirring for 24 hours at 40° C. The solvent and unreacted reagents are evaporated in vacuo.

The obtained product is analysed by NMR. The formation of a small amount of tetrabutyl 2,2′-((6-ethoxy-6-oxohexane-1,5-diyl)bis(azanediyl))disuccinate (diaddition product of dibutyl maleate on ethyl lysinate) (10%) as well as dibutyl N (5-amino-6-ethoxy-6-oxohexyl) aspartate (20%) and ethyl lysinate is observed.

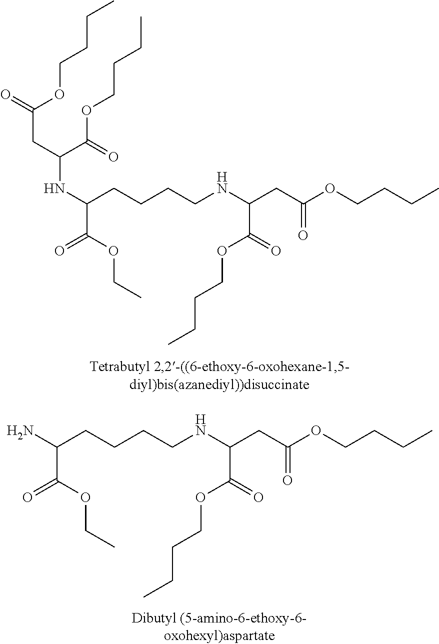 [SMILES: CCCCOC(=O)CC(NCCCCC(NC(CC(=O)OCCCC)C(=O)OCCCC)C(=O)OCC)C(=O)OCCCC ; CCCCOC(=O)CC(NCCCCC(N)C(=O)OCC)C(=O)OCCCC]

### Example 16

### Reaction Product of Example 13 with Ethyl Acrylate

Tetrabutyl 2,2′-((6-ethoxy-6-oxohexane-1,5-diyl)bis-(azanediyl))-disuccinate produced according to Example 14 is taken up with 50 ml of isopropanol and 2 g of ethyl acrylate are added to the reaction medium which is stirred for 8 hours at 50° C. The solvent is evaporated and the product is analysed.

This is a mixture of tetra-butyl 2,2′-((6-ethoxy-6-oxohexane-1,5-diyl)bis-(azanediyl))disuccinate, of dibutyl(6-ethoxy-5-((3-ethoxy-3-oxopropyl)amino)-6-oxohexyl)aspartate and diethyl 3,3′-((6-ethoxy-6-oxohexane-1,5-diyl)bis(azanediyl))dipropionate which is the diaddition product of ethyl acrylate on ethyl lysinate.

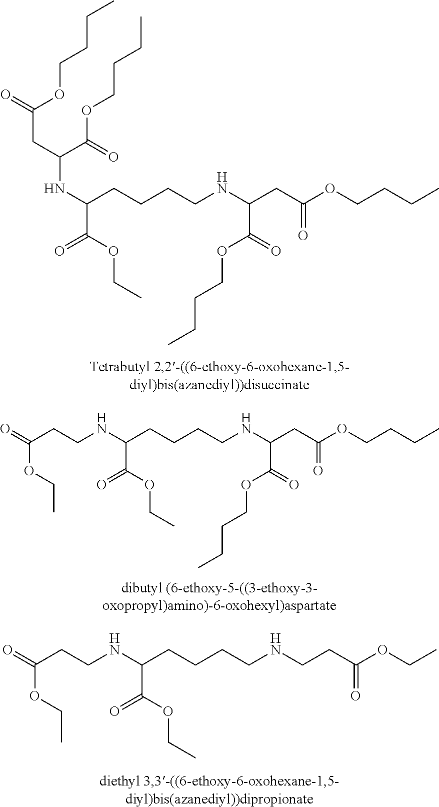 [SMILES: CCCCOC(=O)CC(NCCCCC(NC(CC(=O)OCCCC)C(=O)OCCCC)C(=O)OCC)C(=O)OCCCC ; CCCCOC(=O)CC(NCCCCC(NCCC(=O)OCC)C(=O)OCC)C(=O)OCCCC ; CCOC(=O)CCNCCCCC(NCCC(=O)OCC)C(=O)OCC]

### Examples 17 to 19

### Syntheses of Aminoesters Containing More than Two Secondary Amine Functions

The other aminoesters with secondary amine functions of Table 2 are prepared according to the same operating procedure by adapting the reaction conditions to the reagents used. The reagents, the reaction conditions and the results are shown in Table 2.

| | | Unsaturated | | | Temperature | |
|---|---|---|---|---|---|---|
| | Initial | alpha beta | | Reaction | and | |
| | aminoester/ | compound/ | | solvent | reaction | Obtained |
| Example | Amount | Amount | Base | Amount | time | compounds and yield |
| 17 | Ethyl valinate hydrochloride 5 g (30 mM) | Trimethylol propane triacrylate 3 g (10 mM) | K₂CO₃ 4.5 g | Isopropanol 75 ml | 60° C. 24 h | 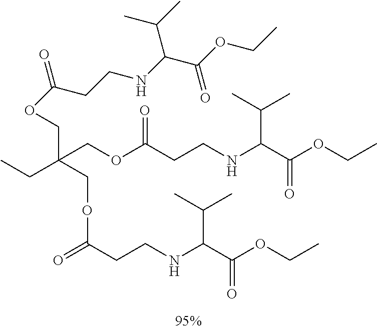 [SMILES: CCOC(=O)C(NCCC(=O)OCC(CC)(COC(=O)CCNC(C(=O)OCC)C(C)C)COC(=O)CCNC(C(=O)OCC)C(C)C)C(C)C] |
| 18 | Ethyl valinate hydrochloride 4 g (16 mM) | Polyethylene glycol diacrylate (Mₙ 575) 5.8 g | K₂CO₃ 2.5 g | Isopropanol 80 ml | 60° C. 24 h | 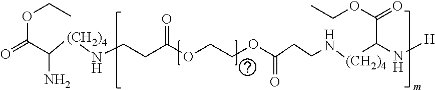 |
| 19 | Ethyl lysinate hydrochloride 4 g (16 mM) | Hexanediol diacrylate 2.4 g (11 mM) | K₂CO₃ 2.5 g | Isopropanol 80 ml | 60° C. 24 h | 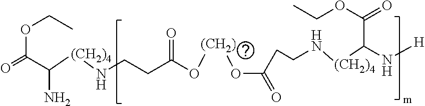 |

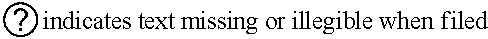

The aminoesters with secondary amine functions of Examples 18 and 19 may also include primary amine functions as end functions.

The aminoester ester with a secondary amine function of Examples 14 to 19 is then used in order to lead to polyurea systems by reaction with an allophanate and another polyisocyanate compound.

### Example 20

### Synthesis of an Aminoester Compound According to the Invention Comprising Secondary Amine Functions

This Example describes the synthesis of an aminoester compound obtained from a mixture of two aminoesters with primary amine functions with an unsaturated alpha beta derivative, hexanediol diacrylate.

In a 50 ml reactor, are successively introduced 30 ml of isopropanol, 2 g of ethyl lysinate hydrochloride and 2 g of methyl amino-undecanoate hydrochloride. 3 g of K₂CO₃ are added and stirring is then left on for 24 hours at 50° C. The reaction medium is left to cool. 50 ml of n-butyl acetate are added to the reaction medium which is filtered. The solvents are then evaporated in order to obtain a mixture of compounds containing secondary amine functions.

### Example 21

### Reactivity of the Aminoesters with Secondary Amine Functions According to the Invention with Compounds with Isocyanate Functions

This example is based on tracking the reaction temperature of an aminoester according to the invention with isophorone diisocyanate (IPDI) in an isopropanol medium.

In a stirred reactor containing 5 to 6 g of isopropanol, the aminoester with a secondary amine function is introduced (1 to 1.5 g) and then the amount of IPDI corresponding to the equimolar reaction of an isocyanate function with a present amine function is then added to the reaction medium in one go. The reaction of the amine function on the isocyanate function is an exothermic reaction and gives the possibility of recording the reaction temperature.

It is noticed that as soon as IPDI is added, the temperature of the reaction medium significantly increases and passes from 22° C. to 24° C. in less than 1 minute and returns to the temperature of 22° C. after 10 minutes of reaction. Monitoring of the isocyanate functions by infrared spectroscopy is conducted after 2 hours at room temperature. It shows the absence of isocyanate functions.

Further, the isopropanol does not interfere with the reaction between the aminoester and isophorone diisocyanate (IPDI). In fact, the reaction of IPDI with isopropanol is very slow and after two hours of reaction, monitoring by infrared analysis shows a characteristic band of isocyanate functions at 2,250 cm¹.

### Example 22

### Reactivity of the Aminoesters with Secondary Amine Functions with an Allophanate of Formula (I) According to the Invention (Product Tolonate X FLO 100)

Tolonate XFLO 100 is a polyisocyanate allophanate, based on HDI, with NCO functionality of 2. It is used as a polyisocyanate hardener during the manufacturing of polyurea coatings. It may be mixed with other polyisocyanate hardeners.

1 g (2.6 mM) of diethyl 3,3′-((6-ethoxy-6-oxohexane-1,5-diyl)-bis(azanediyl))dipropionate (diaddition product of ethyl lysinate on ethyl acrylate) were introduced into a 50 ml reactor equipped with mechanical stirring. 5 ml of isopropanol are added. Next, with stirring, 1.8 g of Tolonate X FLO 100 is added in one go.

An increase in the temperature is immediately noticed which passes from 21° C. to 23° C. within 1 minute and then returns to 21° C. within 30 minutes.

After 2 hours, monitoring is carried out with infrared spectroscopy on the reaction medium. It shows the absence of isocyanate functions.

Tolonate X FLO 100 therefore rapidly reacts with the aminoesters according to the invention and may therefore be used as a polyisocyanate hardener useful for forming polyurea networks.

1. A composition for preparing a coating comprising
(a) at least one compound selected from
a compound of formula (Q) 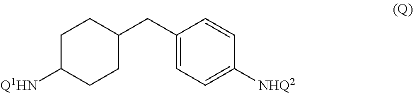
wherein Q¹ and Q², either identical or different, represent a linear, branched or cyclic alkyl group, comprising from 1 to 20 carbon atoms;
a compound comprising at least two secondary amine functions and obtained by reaction
(a1) of at least one compound including at least one primary amine function and
(a2) of at least one compound including a double bond (C═C) located in the α position of an ester function (C(O)OR) or of at least one compound including a double bond (C═C) located in the α position of a nitrile function (CN) or mixtures thereof;
a mixture of a compound of formula (Q) and of a compound comprising at least two secondary amine functions and stemming from steps (a1) and (a2);
(b) an isocyanate component with NCO functionality ranging from 1.6 to 3.5 and comprising
(b1) at least one allophanate of formula (I) and with NCO functionality equal to 2+/−0.1 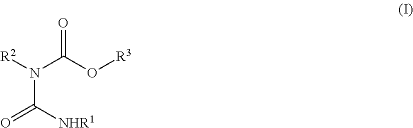
wherein
R¹ and R², either identical or different, represent a hydrocarbon group, comprising a derivatized or non-derivatized isocyanate function;
R³ represents the radical resulting from the reaction of the isocyanate function with the hydrogen of the OH function of an alcohol comprising an ether or polyether function and selected from a silanol; an aliphatic monoalcohol with a linear C₁₂-C₂₀ chain; an aliphatic monoalcohol with a branched C₁₂-C₂₀ chain; or an alcohol of formula
T¹-[O—CH(T²)-CH₂]ₙ—OH
wherein T¹ represents a linear C₁-C₂₀ alkyl group; a branched C₁-C₂₀ alkyl group; a group of formula T³-CO—CH₃ wherein T³ represents a linear C₁-C₂₀ alkyl group or a branched C₁-C₂₀ alkyl group; T² represents H; an alkyl group; an ether group or a group of formula —CH₂OT⁴ wherein T⁴ represents a hydrocarbon chain; n represents an integer; and
(b2) at least one polyfunctional isocyanate; and
(b3) wherein the mass ratio between the amount of allophanate (b1) and the amount of polyfunctional isocyanate (b2) ranges from 1/99 to 50/50.

2. The composition according to claim 1, for which the molar ratio [b/a] defined by [number of NCO functions of component (b)]/[number of NH functions of compound (a)] ranges from 0.7 to 1.3; 0.9 to 1.2; from 1 to 1.2; from 0.8 to 1.2; from 0.9 to 1.2; from 0.8 to 1.1; from 0.9 to 1.1; from 1 to 1.1 or is equal to 1.

3. The composition according to claim 1
for which the compound (a1) comprises at least one primary amine function and at least one group selected from a hydrocarbon chain; a hydrocarbon chain comprising at least one heteroatom selected from O, S, N; a hydrocarbon chain and at least one function selected from an ester, ether or carbonate function; a hydrocarbon chain comprising at least one heteroatom selected from O, S, N and at least one function selected from an ester, ether or carbonate function; or
for which the compound (a1) is an aminoester compound including at least one primary amine function; or
for which the compound (a2) comprises a double bond (C═C) capable of reacting by Michael addition with the primary amine function of the compound (a1) and which is selected from ester derivatives comprising a double bond (C═C); or
for which the compound (a2) is a compound selected from a compound including doubles bonds (C═C) located in the α position of ester functions (C(O)OR); or
combining these definitions of the compounds (a1) and (a2).

4. The composition according to claim 1 for which
the compound (a) is a compound of formula (II-a): 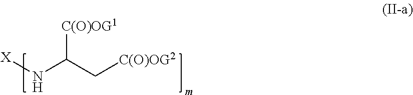
wherein
m represents an integer equal or greater than 2;
X represents a radical with a valence equal to m and selected from an organic radical, a hydrocarbon radical, a C₂-C₅₀ hydrocarbon radical; resulting from the removal of the primary amine functions of the compound (a1);
G¹ and G², either identical or different, independently represent an organic radical, a hydrocarbon radical or a hydrocarbon radical inert towards isocyanate functions under the preparation conditions of the composition; or
a compound of formula (II-b): 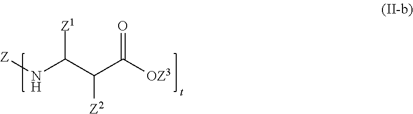
wherein
t represents an integer equal to or greater than 2;
Z represents a radical with a valence equal to m and selected from an organic radical, a hydrocarbon radical, a C₂-C₅₀ hydrocarbon radical; resulting from the removal of the primary amines functions of the compound (a1);
Z¹ independently represents hydrogen or a C₁-C₄-alkyl group;
Z² independently represents hydrogen or a C₁-C₄-alkyl group;
Z³ independently represents an organic radical, a hydrocarbon radical or a hydrocarbon radical inert towards isocyanate functions under the preparation conditions of the composition; or
a mixture of at least one compound of formula (II-a) and of at least one compound of formula (II-b).

5. The composition according to claim 4 for which X represents a divalent radical comprising up to 40 carbon atoms or a radical selected from the radicals of formulae (X¹) to (X⁶)

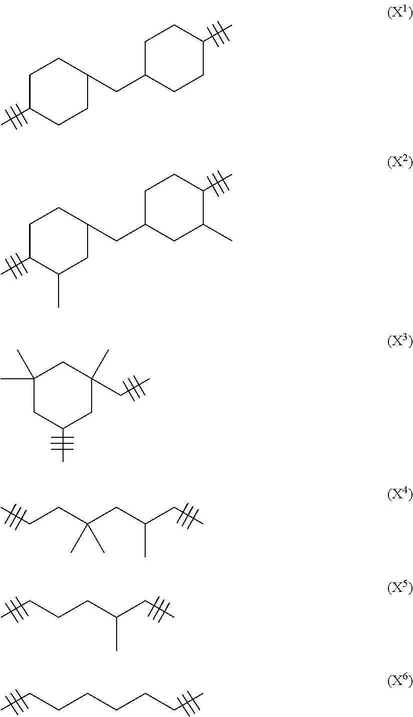

6. The composition according to claim 1, comprising
a compound (a) for which the molecular mass ranges from 400 to 6,500 g·mol⁻¹; or
a compound (a) for which the NH functionality ranges from 2 to 30; or
a compound (a) of formula (II) according to claims 4 or 5 wherein X represents an organic radical of valence m and obtained by reaction of a compound (a1) selected from ethylenediamine, 1,2-diaminopropane, 1,4-diaminobutane, 2-methyl-1,5-diaminopentane, 1,6-diaminohexane, 2,5-diamino-2,5-dimethylhexane, 2,2,4-trimethyl-1,6-diaminohexane, 2,4,4-trimethyl-1,6-diaminohexane, 1,11-diaminoundecane, 1,12-diaminododecane, 1-amino-3,3,5-trimethyl-5-aminomethylcyclohexane, 2,4-hexahydrotolylenediamine, 2,6-hexahydrotolylenediamine, 2,4′-diaminodicyclohexylmethane, 4,4′-diamino-dicyclohexylmethane, 3,3′-dimethyl-4,4′-diamino-dicyclohexylmethane, 2,4,4′-triamino-5-methyldicyclohexylmethane and polyetherpolyamines substituted with at least one primary amino-aliphatic group, for which the average molecular mass ranges from 148 to 6,000 g/mol.

7. The composition according to claim 6 comprising a compound (a) of formula (II) according to claims 4 or 5 wherein X represents an organic radical of valence m and is obtained by the reaction of a compound (a1) selected from 1,4-diaminobutane, 2-methyl-1,5-diaminopentane, 1,6-diaminohexane, 2,2,4-trimethyl-1,6-diaminohexane, 2,4,4-trimethyl-1,6-diaminohexane, 1-amino-3,3,5-trimethyl-5-aminomethylcyclohexane, 4,4′-diaminodicyclohexylmethane, 3,3′-dimethyl-4,4′-diaminodicyclohexylmethane.

8. The composition according to claim 1 for which the compound (b1) is a compound of formula (I), wherein R¹ and R², either identical or different, represent a group comprising a derivatized or non-derivatized isocyanate function and selected from an aliphatic, cycloaliphatic, heterocyclic or aromatic hydrocarbon group, preferably an aliphatic hydrocarbon group comprising a derivatized or non-derivatized isocyanate function.

9. The composition according to claim 1, for which the derivatized isocyanate function of the allophanate (b1) is different from an isocyanurate function and is selected from carbamate, urea, biuret, urethane, uretinedione, acylurea, masked isocyanate, allophanate functions.

10. The composition according to claim 1, for which the allophanate (b1) is a homo-allophanate, R¹ and R² being identical, or for which the allophanate (b1) is a mixed allophanate, R¹ and R² being different.

11. The composition according to claim 1 comprising a mixture of allophanates (b1) comprising at least 25% by mass of at least one monoallophanate (b1).

12. The composition according to claim 1, comprising a mixture of allophanates comprising at least one allophanate selected from a bis-allophanate, a tris-allophanate, one or several heavy allophanates, as well as in a minority way, carbamate of an isocyanate of formula R²NCO and of an alcohol of formula R³OH or carbamate of an isocyanate of formula R¹NCO and of an alcohol of formula R³OH or a mixture of carbamates of isocyanates of formula R²NCO and of formula R¹NCO and of an alcohol of formula R³OH.

13. The composition according to claim 1, for which the compound (b2) is a polyfunctional isocyanate tricondensate, or a polyfunctional isocyanate tricondensate of formula (III): 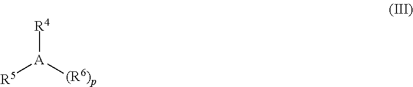
wherein
R⁴, R⁵ and R⁶ independently represent an aliphatic, cycloaliphatic, heterocyclic or aromatic hydrocarbon group or heterocarbon group, comprising at least one derivatized or non-derivatized isocyanate function;
p represents 0, 1 or 2;
A represents a group selected from an isocyanurate group, an imino oxadiazine dione group, an oxadiazine trione group, a biuret group of formulae (A¹) to (A⁴) or a group of formula (A⁵), respectively 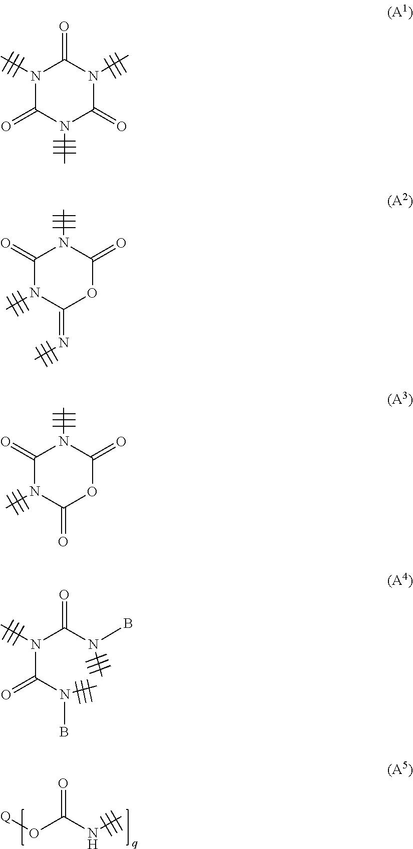
wherein
B independently represents a hydrogen atom; a hydrocarbon group; a C₁-C₂₀ hydrocarbon group; a heterocarbon group comprising at least one heteroatom selected from O, N, S, Si; a C₁-C₂₀ heterocarbon group comprising at least one heteroatom selected from O, N, S, Si;
q represents 3 or 4;
Q represents a group selected from a hydrocarbon group, an alkyl group, a heterocarbon group, an aliphatic, cycloaliphatic, heterocyclic or aromatic heterocarbon group, comprising a derivatized or non-derivatized isocyanate function, a group derived from pentaerythritol, a group derived from trimethylolpropane.

14. The composition according to claim 1, for which the polyfunctional isocyanate (b2) is a polyisocyanate isocyanurate.

15. The composition according to claim 1, for which the polyfunctional isocyanate (b2) is
a polyisocyanate isocyanurate stemming from a tricondensation reaction for which the transformation rate of the isocyanate monomer(s), either identical or different, into a polyfunctional polyisocyanate tricondensate is greater than 8% or greater than 10% or greater than 15%; or
a polyisocyanate isocyanurate comprising between 1 and 99% by weight of biuret or between 2 and 75% by weight of biuret; or
a polyisocyanate isocyanurate stemming from a tricondensation reaction for which the transformation rate of the isocyanate monomer(s), either identical or different, into a polyfunctional polyisocyanate tricondensate is greater than 8% or greater than 10% or greater than 15% and comprising between 1 and 99% by weight of biuret or between 2 and 75% by weight of biuret.

16. The use of a composition according to claim 1 for preparing a coating or for preparing a cross-linkable coating or for preparing a coating which is cross-linkable by UV irradiation or for preparing a coating for which hydrophobicity is improved.

17. The use of a composition according to claim 1 for improving the pot lifetime of a formulation for paint or varnish or for improving the opening time of a film or layer resulting from the application of the composition.
